(19) United States
(12) Patent Application Publication
(10) Pub. No.: US 2026/0017290 A1
(43) Pub. Date: Jan. 15, 2026

(54) METHOD FOR SPATIAL JOIN EXECUTION ON LARGE GEOMETRIC DATASETS

(71) Applicant: Wherobots Inc., Scottsdale, AZ (US)

(72) Inventors: Jia Yu, Mercer Island, WA (US); Bo Peng, Beijing (CN)

(21) Appl. No.: 19/247,840

(22) Filed: Jun. 24, 2025

Related U.S. Application Data
(60) Provisional application No. 63/669,888, filed on Jul. 11, 2024.

(51) Int. Cl. G06F 16/29; G06F 16/22

(52) U.S. Cl. CPC G06F 16/29; G06F 16/2246

(57) ABSTRACT

A computer-implemented method for performing an optimized spatial join operation between geospatial datasets is described. The method includes analyzing each geospatial dataset to extract spatial metadata by performing an one-pass scan of each geospatial dataset to collect spatial metadata. The method further includes applying a heuristic-based method to identify an optimal number of partitions for each geospatial dataset and a hybrid sampling strategy with Reservoir and Bernoulli sampling for each partition. The method also includes generating spatial partitions based on the extracted spatial metadata including shuffling collected samples, increasing the number of samples, and mixing samples from all geospatial datasets. Additionally, the method includes performing a spatial join operation which includes dynamically selecting a spatial index structure to execute local joins within each partition, and executing an adaptive per-partition local join execution plan by estimating which geospatial dataset is smaller and designating the smaller geospatial dataset as a build side.

### CROSS-REFERENCE TO RELATED APPLICATIONS

This application claims priority to and benefit of U.S. Provisional Patent Application No. 63/669,888, filed on Jul. 11, 2024, the entire disclosure of which is hereby incorporated by reference.

### FIELD OF TECHNOLOGY

The method described herein is directed to an optimized spatial join implementation that enables combination of spatial data from different sources based on spatial relationships while offering a balance between performance and tunability.

### BACKGROUND

Spatial join operations are crucial in geographic information systems (GIS) and spatial databases, enabling the combination of spatial data from different sources based on their spatial relationships. A spatial join operation links spatial data from two different datasets based on their spatial relationship. Unlike traditional joins, which use keys and attributes, spatial joins use geometric properties and spatial predicates (e.g., intersects, contains, within). This process is essential for integrating and analyzing spatial data, supporting tasks like map overlay, proximity analysis, and spatial clustering. Spatial join operations are widely used in various domains such as in urban planning (e.g., integrating land use data with transportation networks), environmental monitoring (e.g., combining satellite imagery with ground sensor data), and location-based services (e.g., enhancing services by joining user locations with points of interest).

Handling large spatial datasets introduces several challenges, such as scalability (e.g., ensuring the spatial join operation scales with the size of the datasets), performance (e.g., minimizing computation time and memory usage which is important for real-time or near-real-time applications), and data heterogeneity (e.g., managing and integrating data from diverse sources with varying formats, resolutions, and accuracies).

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### BRIEF SUMMARY

The method described herein is directed to an advanced spatial join algorithm that provides several improvements over traditional legacy spatial join algorithms and legacy spatial join methods. Unlike traditional approaches, it (i) collects statistics and additional metrics from both datasets to optimize the efficiency of later processing phases, (ii) applies a heuristic approach to determine the optimal number of partitions, and (iii) employs a combination of Reservoir sampling and Bernoulli sampling to gather samples and statistics in a single pass. Furthermore, it (iv) performs parallel collection of statistics and samples from both datasets, and (v) uses this information to generate localized join execution plans for each partition while selecting the most appropriate execution mode for each spatial predicate.

The above and other preferred features, including various novel details of implementation and combination of events, will now be more particularly described with reference to the accompanying figures. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. (FIG.) 1 is a schematic diagram illustrating a Spatial Partitioned Dynamically Indexed Join executed using a legacy spatial join algorithm, in accordance with some embodiments.

FIG. 2 is a schematic diagram illustrating a Spatial Partitioned Dynamically Indexed Join executed using an advanced spatial join algorithm, in accordance with some embodiments.

FIG. 3 is a schematic diagram depicting a sampling operation performed by an advanced spatial join algorithm, in accordance with some embodiments.

FIG. 4 is an exemplary algorithm for merging sample collections obtained from multiple spatial partitions, in accordance with some embodiments.

FIG. 5 is a timeline diagram showing the execution of a legacy spatial join algorithm across four executor cores, sequentially processing two analysis jobs on datasets with 10 and 5 partitions, respectively, in accordance with some embodiments.

FIG. 6 is a timeline diagram showing the execution of an advanced spatial join algorithm across four executor cores, sequentially processing two analysis jobs on datasets with 10 and 5 partitions, respectively, in accordance with some embodiments.

FIG. 7 is a schematic diagram illustrating parallel scheduling of spatial join tasks performed by an advanced spatial join algorithm, in accordance with some embodiments.

FIG. 8 is a diagram showing partitioning grids generated by a legacy spatial join algorithm for two joined datasets, in accordance with some embodiments.

FIG. 9 is a diagram showing partitioning grids generated by an advanced spatial join algorithm for two joined datasets, in accordance with some embodiments.

FIG. 10 is a diagram illustrating a spatial partition derived from ordered samples following a Gaussian distribution, in accordance with some embodiments.

FIG. 11 is a diagram illustrating a spatial partition derived from shuffled samples following a Gaussian distribution, in accordance with some embodiments.

FIG. 12 is a diagram showing 25 spatial partitions generated from a synthetic dataset with a Gaussian distribution using 100 samples, in accordance with some embodiments.

FIG. 13 is a diagram showing 25 spatial partitions generated from a synthetic dataset with a Gaussian distribution using 1000 samples, in accordance with some embodiments.

FIG. 14 is a graph illustrating a performance comparison between Sort-Tile-Recursive (STR) and Quad trees across more than 700 spatial joins on over 30 synthetic datasets, in accordance with some embodiments.

FIG. 15 is a schematic diagram illustrating various parameters that may be configured for each partition during local spatial join execution, in accordance with some embodiments.

FIG. 16 is an exemplary pseudocode for implementing various execution modes in spatial join operations, in accordance with some embodiments.

### DETAILED DESCRIPTION

Spatial join operations are fundamental in spatial databases and geographic information systems (GIS), enabling the combination of spatial data based on their spatial relationships rather than traditional keys or attributes. These operations leverage spatial predicates such as “intersects,” “contains,” and “within” to determine the relationships between geometries. Efficient execution of spatial joins, particularly for large datasets, relies heavily on spatial indexing methods like R-trees and Quad-trees, which significantly reduce the number of required comparisons by quickly identifying candidate geometries. Several algorithms, including nested loop joins, spatial hash joins, and tree-based joins, are used to perform spatial joins, each with different efficiency and performance characteristics. Large-scale spatial join operations face challenges related to scalability, performance, and data heterogeneity, often addressed through parallel processing, distributed computing frameworks like Hadoop and Spark, and approximate methods that balance accuracy with speed. These operations are crucial in various applications, from urban planning and environmental monitoring to enhancing location-based services, providing the necessary tools to integrate and analyze complex spatial data effectively.

As mentioned above, spatial joins rely on spatial predicates to determine relationships between geometries, such as intersects, contains, and within. Intersects checks if two geometries share any portion of space; contains determines if one geometry entirely contains another; and within checks if a geometry is entirely within another.

WherobotsDB is a high performance, distributed spatial database system designed to manage and query very large-scale spatial data efficiently. It is built on Apache Sedona (formerly known as GeoSpark), which is an open-source cluster computing system for processing large-scale spatial data. Spatial join in Sedona typically requires proper tuning for fast execution, especially when dealing with medium (e.g., 100 GB) to large-sized (e.g., 500 GB to 1 TB) datasets. Running a spatial join without tuning may lead to one or more of memory shortages, poor performance, and waiting for straggler tasks to complete. In the context of distributed computing and parallel processing, a straggler task refers to a task that takes significantly longer to complete than other tasks in the same job. For this reason, straggler tasks can be a major bottleneck in the overall performance of distributed systems because they delay the completion of the entire job. The method disclosed herein improves on existing spatial join implementations so that spatial joins may provide fast execution without tuning. According to some embodiments, the optimizations disclosed herein provides an out-of-the-box solution.

### Improvements Over Existing Spatial Join Algorithms

WherobotsDB includes several spatial join algorithms and operations to efficiently process and analyze spatial data. Two of these spatial join algorithms used by Sedona SQL (Structured Query Language), referred to herein as “legacy spatial join algorithm” or “legacy spatial join,” are the spatial partitioned dynamically indexed join algorithm and the broadcast indexed join algorithm. The spatial partitioned dynamically indexed join algorithm is described by Jia Yu, Zongsi Zhang, and Mohamed Sarwat in Spatial data management in Apache Spark: the GeoSpark perspective and beyond. Geoinformatica 23, 1 (January 2019), pp. 37-78 https://doi.org/10.1007/s10707-018-0330-9. The spatial partitioned dynamically indexed join algorithm typically combines large sets of spatial data, such as maps or geographical coordinates, efficiently by fragmenting or partitioning the data and using special indexes to speed up the process. The broadcast indexed join algorithm performs join operations between two datasets. This algorithm is especially useful when one of the datasets is small enough to be broadcasted to all worker nodes in a cluster.

The spatial partitioned dynamically indexed join algorithm is used when both joined datasets are large (e.g., above the auto broadcast threshold). One of the joined datasets is picked as the “dominant side” (e.g., Dataset A) for partitioning the space. The “dominant side” refers to the source of data that is typically the largest or more complex in terms of size and its impact on performance and resources. FIG. 1 illustrates a schematic representation of the operational flow of a spatially partitioned, dynamically indexed join algorithm. The algorithm executes in three primary phases, including the following operations: (i) analyzing the dominant dataset to determine a total count (i.e., the number of data entries) and a spatial boundary (i.e., the geographic extent of the dataset); (ii) computing a sampling ratio based on the total count and initiating a secondary job to extract a representative sample from the dominant dataset; (iii) utilizing the obtained samples and the spatial boundary to perform spatial partitioning, wherein the geometric space is subdivided into smaller, computationally manageable regions; (iv) applying a spatial partitioning mechanism to both the dominant and non-dominant datasets based on the defined partitions; and (v) executing local spatial join operations on the partitioned datasets, followed by a deduplication process to generate a final, non-redundant join result. As shown in FIG. 1, each phase may include one or more of the above operations. For example, the “Analyze Phase” may include operations (i)-(ii), the “Spatial Partitioning Phase” may include operations (iii)-(iv), and the “Join Phase” may include operation (v). A drawback of this approach is that the aforementioned process requires substantial tuning. For instance, several parameters must be carefully configured, including determining the dominant side (i.e., the primary dataset), determining the optimal number of spatial partitions, selecting an appropriate spatial indexing algorithm for the join phase, and choosing the correct side to index during the join, each of which demands significant user involvement and active engagement.

In contrast, the method disclosed herein introduces a novel spatial join algorithm, referred to as the “advanced spatial join algorithm” or simply “advanced spatial join,” designed to overcome the limitations of conventional spatial join techniques. According to certain embodiments, the advanced spatial join achieves performance comparable to that of a finely tuned legacy spatial join—without requiring manual parameter tuning.

Specifically, the advanced spatial join offers the following key advantages over traditional approaches: (i) it eliminates the need to designate a dominant dataset; (ii) it collects statistics and representative samples from both input datasets; and (iii) it autonomously optimizes both the spatial partitioning and join phases. In particular, the spatial join phase is restructured to dynamically select the most effective local join parameters for each partition, based on the collected statistics and sampling data.

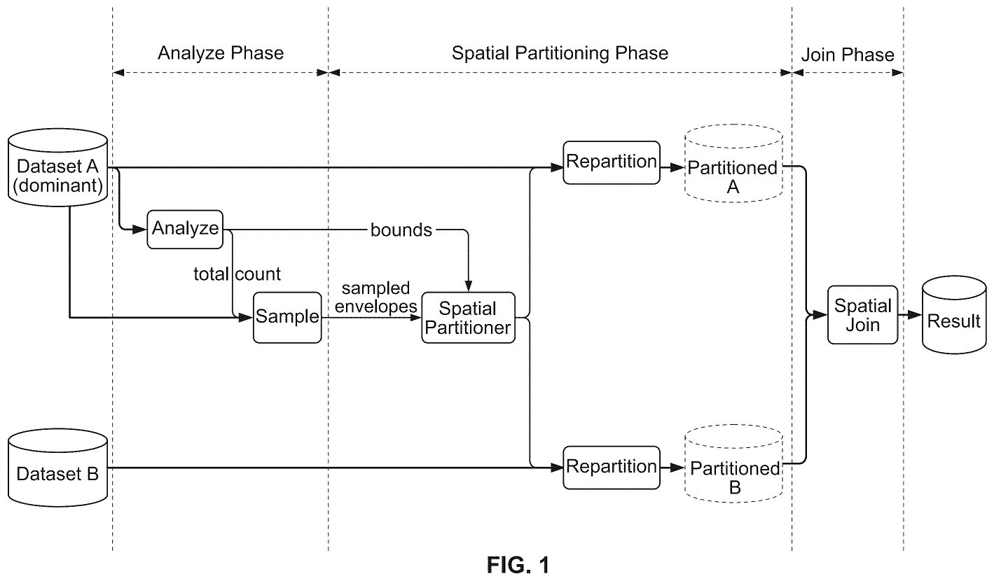

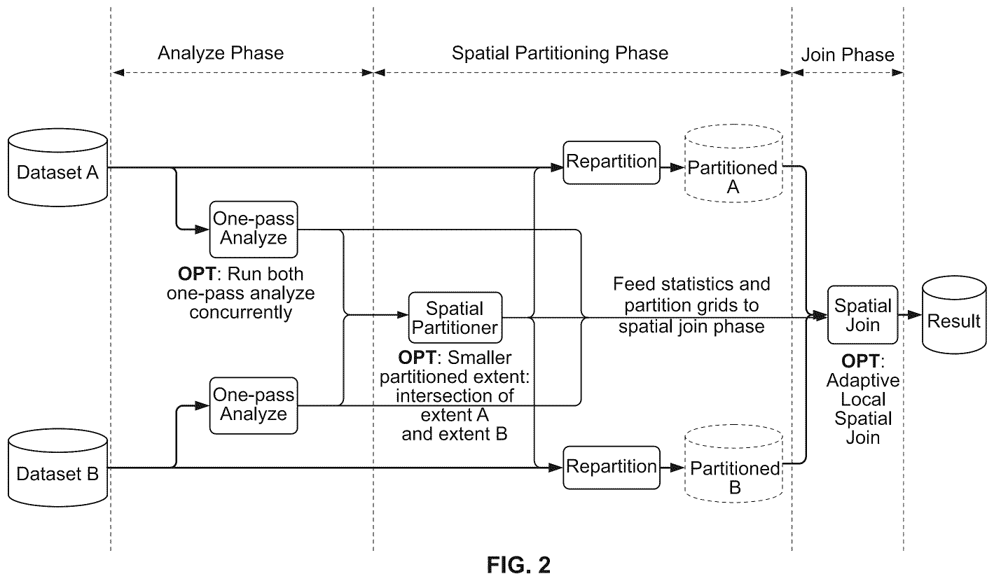

According to some embodiment, FIG. 2 is block diagram of a method based on the advanced spatial join disclosed herein for optimized spatial join processing between two geospatial datasets, referred to as Dataset A and Dataset B. The process is structured into three sequential phases: the Analyze Phase, the Spatial Partitioning Phase, and the Join Phase.

In the Analyze Phase, each dataset undergoes a one-pass analysis to extract a comprehensive set of spatial metadata. During this process, a heuristic-based method is applied to estimate the optimal number of spatial partitions for each dataset. To enhance efficiency, the advanced spatial join algorithm utilizes a hybrid sampling strategy that combines Reservoir sampling and Bernoulli sampling. This approach enables the simultaneous collection of statistical summaries and a uniform random sample in a single scan, without requiring prior knowledge of the dataset size. Optionally, the algorithm can support concurrent execution of the analysis tasks for both datasets, thereby improving overall processing performance.

The spatial metadata extracted during the Analyze Phase is passed to the Spatial Partitioning Phase, where a Spatial Partitioner module utilizes the intersection of the spatial extents of both datasets as the basis for partitioning. Specifically, the algorithm automatically computes the overlapping region between the bounding boxes of the two datasets and subdivides this intersection to generate a spatial partition grid. This targeted approach increases the likelihood that each partition will contain relevant features from both datasets, thereby improving join efficiency. To further enhance partition quality, the algorithm shuffles the collected samples to eliminate spatial bias and irregularities. Additionally, the number of samples used in the partitioning process is increased to promote the formation of more uniform and balanced partition grids. By mixing samples from both datasets prior to partitioning, the algorithm more accurately captures the spatial distribution of the join workload, resulting in partitions that are better aligned with the actual data layout.

In the Join Phase, the system performs a spatial join operation utilizing the partitioned datasets, spatial statistics, and partitioning grids. This phase may optionally incorporate an adaptive local spatial join methodology, which dynamically selects the most efficient spatial index structure—such as Quadtrees or Sort-Tile-Recursive (STR) trees—to execute local joins within each partition. Additionally, the Join Phase employs an adaptive per-partition local join execution plan. This plan estimates the relative size of each dataset within a partition using sample counts and designates the smaller dataset as the build side, i.e., the dataset used to construct the spatial index. This strategy minimizes memory consumption and enhances execution efficiency. To further optimize performance, the Join Phase utilizes prepared geometry techniques. By preprocessing geometric data into optimized data structures, the system accelerates spatial operations, particularly improving the performance of computationally intensive spatial predicates.

The outputs of the local joins are then aggregated to produce the final spatial join result. The architecture supports modular and parallel execution, enabling scalability across distributed computing environments and improving overall performance and efficiency in spatial data processing workflows.

### I. Collecting Statistics From Both Input Datasets

In some embodiments, FIG. 2 provides a schematic overview of the operational flow of the advanced spatial join algorithm described herein. As previously noted, a key limitation of legacy spatial join algorithms is the requirement for the user to manually select a dominant dataset to achieve acceptable performance. This constraint arises because only the dominant dataset is utilized during the analysis phase, which directly influences the quality of the resulting spatial partitioning. Poor partitioning can significantly degrade join performance due to imbalanced workloads or inefficient spatial indexing.

In contrast, the advanced spatial join algorithm disclosed herein eliminates the need for such manual intervention. It collects statistics and representative samples from both input datasets, thereby removing the dependency on a predefined dominant side. This dual-sided analysis enables the construction of consistently high-quality spatial partitions, leading to more robust and efficient join performance across a wide range of data distributions.

### A. List of Collected Metrics

Legacy spatial join algorithms typically collect only basic dataset metadata, such as the total record count and spatial boundaries. In contrast, the advanced spatial join algorithm gathers a broader set of metrics (collectively referred to herein as “spatial metadata”) to enable more efficient execution of subsequent processing phases. It is noted, however, that the collection of these additional metrics may introduce overhead during the analysis phase. According to some embodiments, the advanced spatial join collects the metrics listed in Table 1 below.

TABLE 1
Metrics Collected by the Advanced Spatial Join Algorithm

| Metric | Meaning | Purpose |
|---|---|---|
| count | Total number of | Used to determine the |
| | rows | number of spatial |
| | | partitions and the build/ |
| | | stream side in local joins |
| boundary | Spatial extent of | Guides spatial |
| | the dataset | partitioning |
| mean_size | Average size (in | Helps determine the |
| | bytes) of each | number of spatial |
| | geometry, including | partitions |
| | user data | |
| puntal_count | Total number of | Informs execution mode |
| | point geometries | for local spatial joins |
| lineal_count | Total number of | Informs execution mode |
| | linestrings | for local spatial joins |
| | geometries | |
| polygonal_count | Total number of | Informs execution mode |
| | polygon geometries | for local spatial joins |
| mean_num_points | Average number of | Determine execution |
| | points per geometry | mode for local spatial |
| | | join |
| mean_envelope_width | Average width of | Currently not used |
| | geometry envelopes | |
| mean_envelope_height | Average height of | Currently not used |
| | geometry envelopes | |
| mean_envelope_area | Average area of | Currently not used |
| | geometry envelopes | |

Experimental results indicate that collecting the metrics listed in Table 1 has no measurable impact on the performance of the analysis phase. In some embodiments, the specific set of metrics collected may be selected based on their contribution to spatial join efficiency. Additionally, certain metrics may not be computed for every geometry in the dataset. For example, mean_size may be estimated rather than calculated exhaustively. In some implementations, metric sampling is performed periodically—for instance, by estimating geometry size for every K geometries, where K increases exponentially at a rate of 1.2. This adaptive sampling strategy is similar to techniques employed by Apache Spark to manage heap memory usage during memory-intensive operations.

### B. Heuristics for Partition Selection

In some implementations, a heuristic-based method is employed to estimate the appropriate number of partitions. The heuristics formula for determining the number of partitions p based on dataset-specific statistics can be written in the form of formula (1) below:

$$p = max ( {p}_{mem} , {p}_{count} ) , \qquad ( 1 ) .$$

The variables

$${p}_{mem} = \frac{count \times mean\_size \times {M}_{executor}}{{N}_{executor core}} and {P}_{count} = \frac{count}{10 , 000 , 000}$$

represent relevant statics parameters. The final number of partitions is determined as the maximum value of p computed independently for each dataset. This heuristic is designed to mitigate the risk of memory exhaustion during in-memory loading of geometries and to ensure that each spatial partition contains fewer than 10 million geometries.

### C. One-Pass Sampling and Statistics

During the analysis phase, the legacy spatial join algorithm collects samples from the dominant dataset, as illustrated in FIG. 1. The sampling rate is determined based on the total number of records in the dataset and the number of spatial partitions—a parameter that, as previously discussed, requires tuning. Typically, the algorithm limits the number of samples to the lesser of 1,000 or twice (2×) the number of spatial partitions. If the dataset is large and this limit is exceeded, the algorithm defaults to sampling 1% of the total records. Since the algorithm has prior knowledge of the dataset size, this sampling process is relatively straightforward. The objective is to collect a sufficient number of samples to generate high-quality spatial partitions, even for small datasets, while avoiding excessive sampling in large datasets to minimize memory overhead. Ideally, the sampling should be uniform to ensure that the collected samples accurately represent the overall data distribution.

In contrast to the legacy spatial join, the advanced spatial join algorithm scans both datasets during the analysis phase, as illustrated in FIG. 2. While the legacy approach might require up to four scans (two per dataset), repeating this process in the advanced algorithm would introduce significant memory overhead—something the design aims to avoid. To minimize memory overhead while still gathering meaningful insights, the advanced spatial join algorithm collects both statistics and a uniform random sample during each scan—without requiring prior knowledge of the dataset size. To accomplish this, the advanced spatial join algorithm employs a hybrid sampling strategy that combines Reservoir sampling and Bernoulli sampling. Reservoir sampling allows for the uniform selection of a fixed number of elements from a dataset (or stream) of unknown size, ensuring each element has an equal chance of being chosen. Bernoulli sampling includes each element independently with a fixed probability p, enabling probabilistic control over the sample size. The advanced spatial join algorithm aims to collect at least Nₘᵢₙ and at most Nₘₐₓ samples per partition. It also ensures that the sampling rate does not fall below a minimum threshold R before reaching Nₘₐₓ. Throughout the process, the advanced spatial join algorithm maintains a set of sampled envelopes S, which represent the bounding boxes of spatial objects selected during sampling. The purpose of S is to maintain a representative subset of these envelopes as the dataset is processed, enabling efficient estimation, filtering, or adaptive behavior in the join algorithm. As the number of observed records k increases, the advanced spatial join algorithm progresses through four stages described below, dynamically adjusting its behavior. Here, k denotes the number of envelopes processed from the data stream.

According to some embodiments, the four stages and the conditions for each stage are described in Table 2 below.

TABLE 2
Stages and Conditions during Dataset Scanning

| Stage Description | Description | Condition |
|---|---|---|
| Stage 1: | Add the envelope (bounding box) | When k < Nₘᵢₙ |
| Initial Envelope Collection | of each spatial object to the | |
| | sample set S. | |
| Stage 2: Small Reservoir Sampling | Apply reservoir sampling to maintain a fixed-size set of | $When {N}_{min} \leq k < \frac{{N}_{min}}{R}$ |
| | sampled envelopes (Nₘₐₓ) in S. | |
| Stage 3: Bernoulli Sampling | Use Bernoulli sampling to probabilistically accept new | $When k \geq \frac{{N}_{min}}{R} and$ |
| | envelopes. The sample set S may | \|\|S\|\| < Nₘₐₓ |
| | grow in this stage. | |
| Stage 4: | Reapply reservoir sampling to | When \|\|S\|\| = Nₘₐₓ |
| Large Reservoir Sampling | maintain exactly (Nₘₐₓ) in S | |

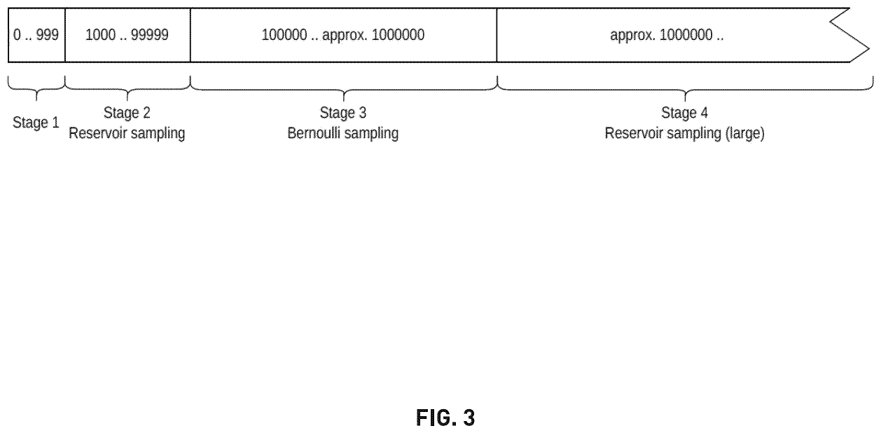

The four stages in Table 2 above are schematically illustrated in FIG. 3. In Stage 1, when fewer than Nₘᵢₙ envelopes have been seen, the advanced spatial join algorithm simply adds each envelope directly to S, ensuring that a minimum number of samples are collected. Once k reaches Nₘᵢₙ, Stage 2 begins. In Stage 2, reservoir sampling is used to maintain a fixed-size sample set of envelopes, capped at Nₘₐₓ, while k remains below the threshold

$$\frac{{N}_{m i n}}{R} .$$

This ensures uniform sampling without prior knowledge of the total dataset size. As k exceeds

$$\frac{{N}_{m i n}}{R} ,$$

the advanced spatial join algorithm enters Stage 3, where Bernoulli sampling is applied. In Stage 3, each new envelope is independently accepted into S with a fixed probability, allowing the sample set to grow while maintaining probabilistic control over its size. This continues until S reaches the maximum allowed size Nₘₐₓ. Finally, in Stage 4, once S is full, the advanced spatial join algorithm reverts to reservoir sampling to maintain exactly Nₘₐₓ envelopes. This ensures that the sample set remains bounded in size while preserving uniform randomness across the stream. Thus, based on the above, as the number of observed envelopes k increases, the advanced spatial join algorithm transitions through the four distinct stages to balance statistical representativeness with memory efficiency.

The sampling process described above ensures the following:
(i) Sufficient sampling for small partitions—if a partition contains more than Nₘᵢₙ rows, at least Nₘᵢₙ samples will be collected. if the partition contains fewer than Nₘᵢₙ rows, all rows will be included in the samples.
(ii) Controlled sampling for large partitions—The number of samples collected remains bounded, regardless of the partition size, ensuring memory efficiency (i.e., ∥S∥≤Nₘₐₓ).
(iii) Uniform randomness across all stages—Despite the advanced spatial join algorithm progressing through four distinct stages, the overall sampling remains uniform, preserving the statistical integrity of the sample set.

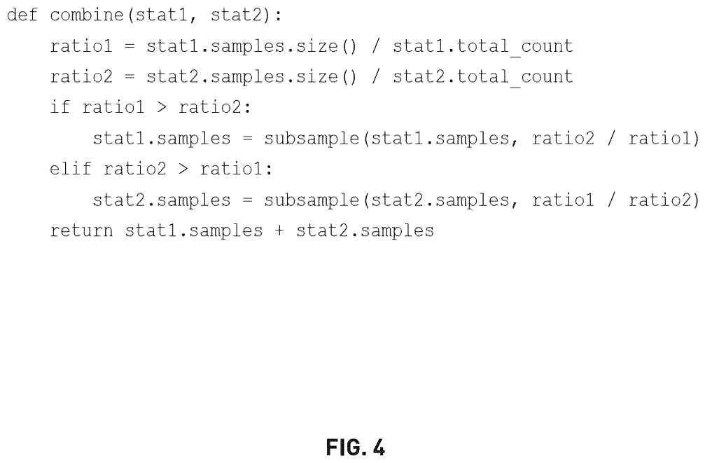

After collecting samples from each partition, the resulting sample sets may be merged into a unified sample collection. According to some embodiments, FIG. 4 illustrates an exemplary sample merging algorithm configured to combine these independently collected sample sets during the analysis phase of the advanced spatial join algorithm. Each partition generates its own sample set using the hybrid sampling strategy described above, which combines Reservoir sampling and Bernoulli sampling. The merging algorithm shown in FIG. 4 ensures that the final, unified sample maintains a consistent and statistically meaningful sampling ratio across all partitions. To achieve this, the algorithm may subsample one or more partition-level sample sets so that all merged samples reflect a comparable sampling ratio. The effective sampling ratio of the final merged sample is bounded by the lowest sampling ratio among the contributing partitions. As previously described, the per-partition sampling algorithm is designed to maintain a sampling ratio no lower than a predefined threshold R. Accordingly, unless the dataset is highly skewed (e.g., with significantly imbalanced partition sizes) or exceptionally large, the overall sampling ratio of the merged dataset will typically remain greater than or equal to R. This approach enables the collection of a statistically representative and memory-efficient sample without requiring prior knowledge of partition sizes or global dataset characteristics. In some embodiments, both the per-partition sampling algorithm and the sample merging algorithm operate as integrated processing steps within the broader spatial join workflow.

Referring now to FIG. 4, the sample merging algorithm begins by computing the sampling ratio for each partition. This ratio is determined by dividing the number of samples collected from a partition by the total number of records in that partition. If the sampling ratios differ, the algorithm subsamples the partition with the higher ratio to match the lower one. This is accomplished by randomly selecting a subset of samples from the higher-ratio partition, using a subsampling probability equal to the ratio of the lower sampling rate to the higher sampling rate. Once the sampling ratios are aligned, the sample sets from both partitions are merged into a single collection. This ensures that the final combined sample reflects a uniform and consistent sampling ratio, bounded by the lowest effective sampling rate among the input partitions.

### D. Parallel Analysis of Both Datasets

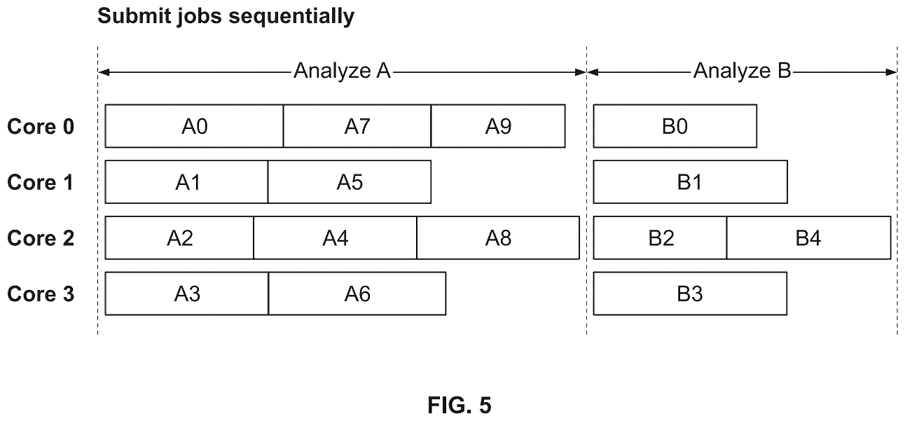

In the analysis phase of the legacy spatial join algorithm, the two required scans on the dominant dataset are executed sequentially. This is because the sampling operation depends on the completion of the initial analysis job. For example, FIG. 5 illustrates an execution timeline for the legacy spatial join algorithm, where four executor cores process two analysis jobs sequentially across two datasets containing 10 and 5 partitions, respectively. As shown in FIG. 5, when the first analysis job (Analyze A) nears completion, some executor cores become idle while others continue processing straggler partitions. The second analysis job (Analyze B) is not submitted until Analyze A has fully completed, resulting in underutilization of computational resources and increased total execution time.

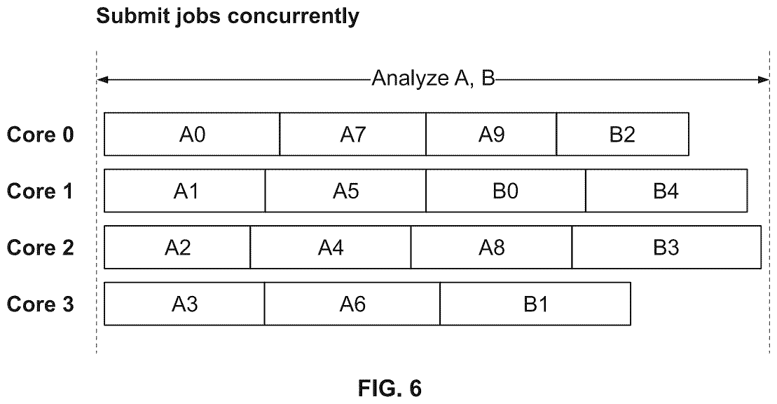

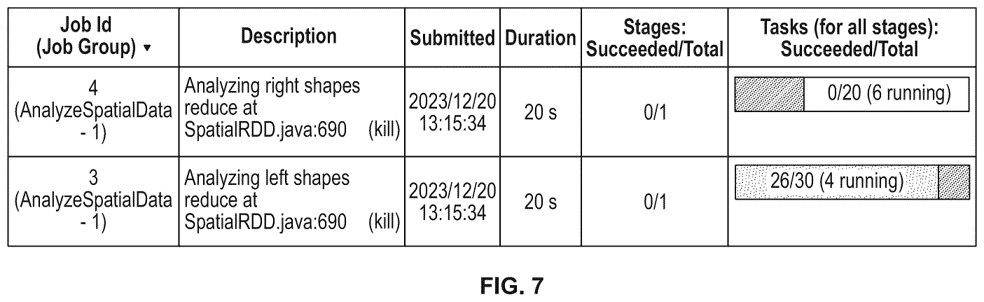

In contrast, the advanced spatial join algorithm disclosed herein enables the analysis jobs for both datasets to be executed concurrently. This parallel execution model allows both analysis jobs (e.g., Analyze A and Analyze B) to be submitted simultaneously, thereby improving the utilization of available executor cores. FIG. 6 schematically illustrates this concurrent scheduling approach. As shown, tasks from both jobs are interleaved and scheduled together, leading to more efficient use of computational resources and a shorter overall analysis phase compared to the sequential approach depicted in FIG. 5. In some embodiments, the scheduling is performed using a First-In, First-Out (FIFO) scheduler, which processes tasks in the order they are submitted without prioritization. While concurrent job submission introduces additional complexity—such as the need to cancel the remaining job if one fails—this approach offers significant performance benefits. Proper error handling mechanisms are employed to ensure that failures are managed cleanly and consistently. According to some embodiments, FIG. 7 illustrates this parallel scheduling in practice, where the analysis of the right-side dataset begins before the analysis of the left-side dataset has completed.

### II. Spatial Partitioning

During the analysis phase described above, the advanced spatial join algorithm collects both statistical summaries and sampled geometry envelopes from each dataset. This richer set of information enables the generation of higher-quality spatial partitions. By leveraging insights from both sides of the join, the algorithm can produce spatial partitions that are more balanced in terms of data distribution, thereby reducing the likelihood of straggler tasks and improving overall load balancing during the local spatial join phase.

### E. Partitioning Based a Smaller Spatial Extent

In contrast, the legacy spatial join algorithm typically partitions the spatial extent of the dominant dataset. However, if the extent of the non-dominant dataset is significantly smaller—or if the intersection between the two extents is minimal—this approach can result in inefficient partitioning. Large portions of the partitioned space may not intersect with the smaller dataset, leading to wasted computation and memory. In this context, the term extent refers to the bounding box that defines the minimum and maximum coordinates encompassing a dataset, partition, or geographic region.

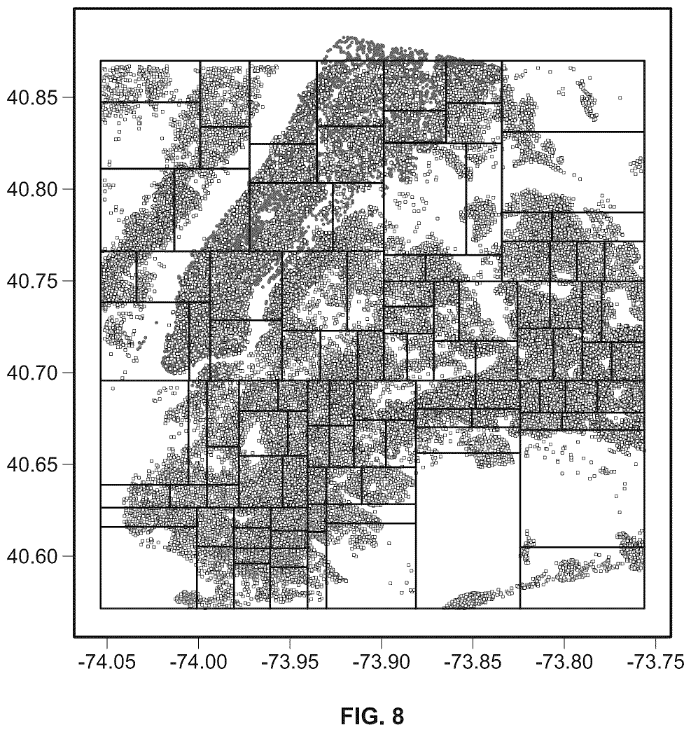

FIG. 8 illustrates this inefficiency using an example where the OSM (OpenStreetMap) nodes dataset for Manhattan (shaded dots) is joined with the Overture Buildings dataset for New York City (white squares), with the latter designated as the dominant side. Because the Overture dataset has a much larger spatial extent, the resulting partition grid includes many regions that do not intersect with the Manhattan dataset (shaded dots). This leads to unnecessary partitions and underutilized compute resources.

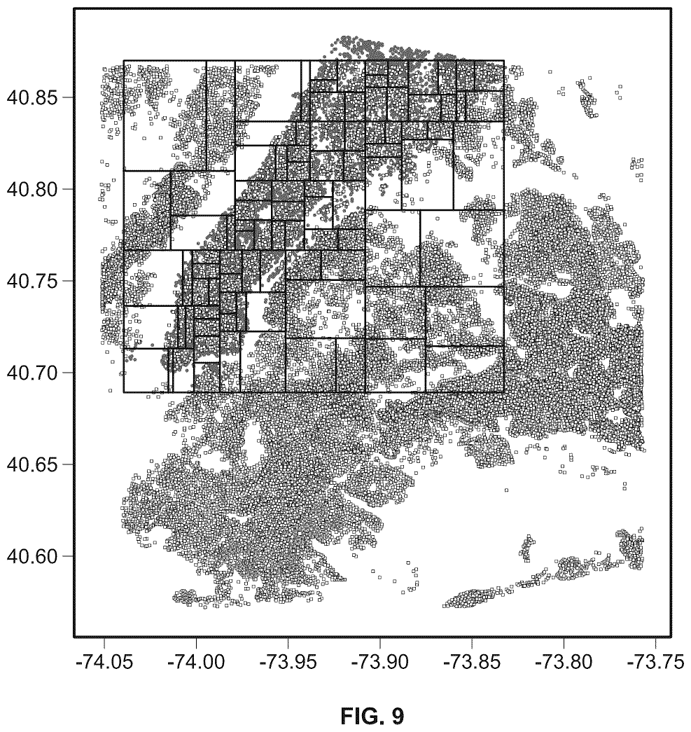

As shown in FIG. 9, the advanced spatial join algorithm addresses this issue by using the intersection of the spatial extents from both datasets as the basis for partitioning. According to some embodiments, the algorithm automatically computes the overlapping region between the two bounding boxes and subdivides this intersection to generate the spatial partition grid. This results in partitions that are more likely to contain relevant data from both datasets, as demonstrated in FIG. 9, where most partitions intersect with both the Manhattan (shaded dots) and New York (white squares) datasets. This approach eliminates the need for users to manually select the dataset with the smaller extent as the dominant side. Instead, the algorithm dynamically determines the optimal partitioning extent, leading to more efficient and balanced spatial joins

### F. Methodologies to Produce Improved Spatial Partitioning

### 1. Shuffling Samples to Improve Partition Uniformity

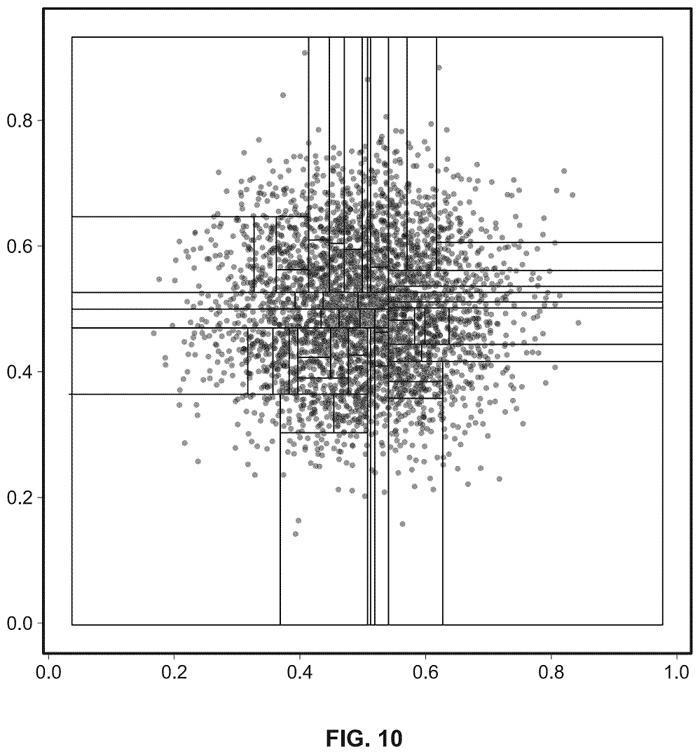

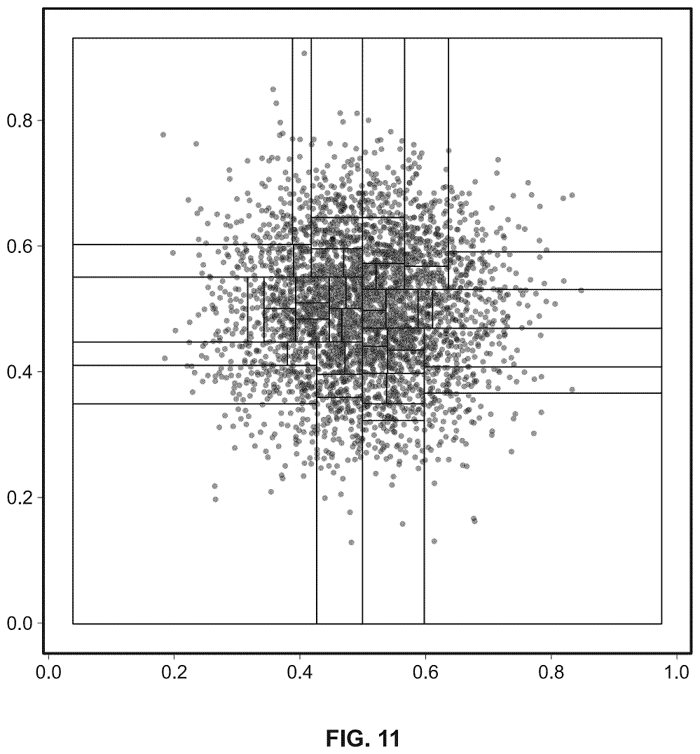

When sample data is spatially ordered—such as when geometries are read from GeoParquet files sorted by spatial indices like GeoHash or Hilbert curves—the resulting spatial partitions may become uneven or biased. According to some embodiments, shuffling the samples prior to partitioning can significantly improve partition quality. FIGS. 10 and 11 illustrate this effect using a synthetic dataset with a Gaussian distribution. FIG. 10 shows spatial partitions generated from ordered samples, while FIG. 11 shows partitions generated from the same dataset after shuffling the samples. As depicted, the shuffled samples produce more uniformly shaped and evenly distributed partition grids, which can lead to better load balancing during spatial joins.

### 2. Effect of Sample Size on Partition Quality

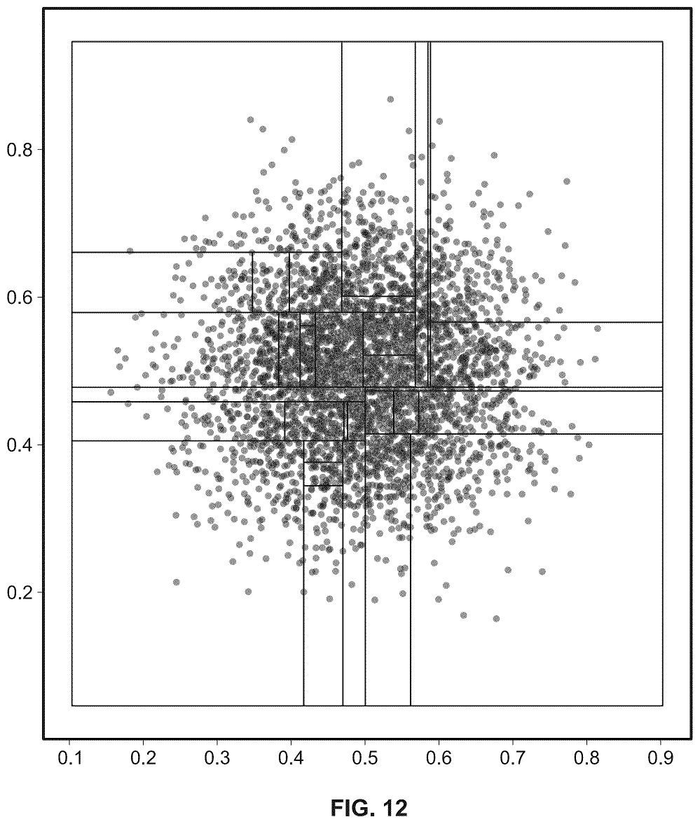

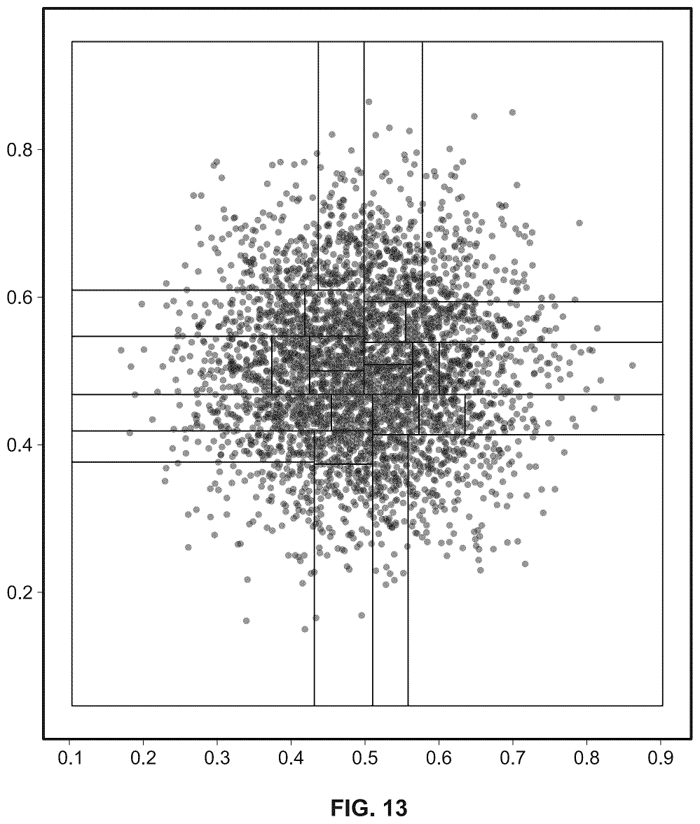

According to some embodiments, increasing the number of samples used for spatial partitioning produces more regular and square-shaped partition grids. FIGS. 12 and 13 demonstrate this effect using the same synthetic dataset with a Gaussian distribution. FIG. 12 shows 25 spatial partitions generated using 100 samples, while FIG. 13 shows partitions generated using 1,000 samples. As illustrated, a larger sample size results in finer-grained and more balanced partitions, thereby improving the overall quality and efficiency of the spatial join process.

### 3. Combining Samples From Both Datasets

In some embodiments, combining samples from both datasets—rather than sampling from only one side—can yield more effective spatial partitions. By mixing samples from both sides before partitioning, the algorithm can better capture the spatial distribution of the join workload. While more sophisticated partitioning strategies may offer marginal improvements in balance, they typically do not result in significant gains in overall execution time. Thus, the mixed-sample approach offers a practical balance between partition quality and computational efficiency.

### III. Local Join Execution

According to some embodiments, once both datasets are partitioned using a common partitioning grid, corresponding partitions—identified by matching partition indices—may be paired to perform local spatial join operations. The local join phase may leverage the statistics and sampled geometry envelopes collected during the analysis phase to optimize execution parameters and improve performance.

### 1. Spatial Index Selection

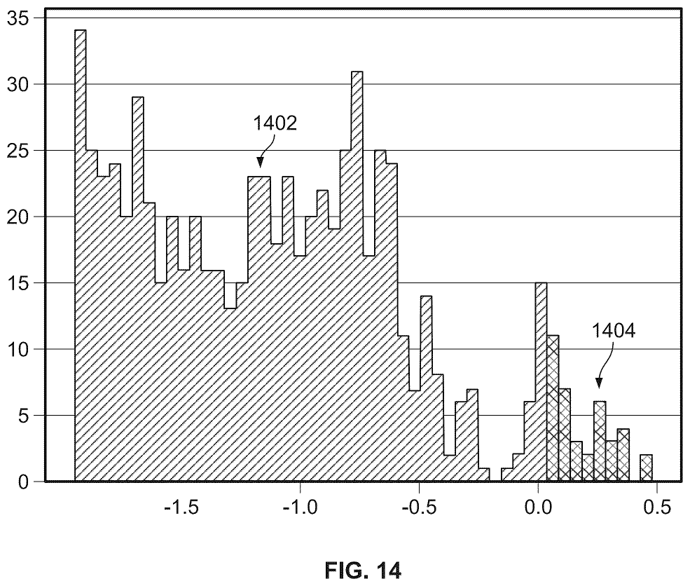

The spatial join system using the advanced spatial join algorithm may support multiple spatial indexing structures, including but not limited to Quad trees and Sort-Tile-Recursive (STR) trees. A Quad tree is a hierarchical spatial index that is simple to implement and is used by default in legacy spatial join operations executed via SQL. An STR tree, by contrast, is an immutable and balanced spatial index that generally provides superior performance across a wide range of spatial workloads. In some embodiments, the advanced spatial join algorithm utilizes the STR tree as the default indexing structure. FIG. 14 illustrates a performance comparison between STR and Quad trees across more than 700 spatial joins on over 30 synthetic datasets. Histogram 1402 in the figure indicates scenarios in which the STR tree outperforms the Quad tree represented by histogram 1404. In the example of FIG. 14, a spatial intext score S is used to evaluate which spatial index performs better. In this context, the spatial intext score S is provided by the following formula:

$$S = 2 \frac{{T}_{STR} - {T}_{Quad}}{{T}_{STR} + {T}_{Quad}}$$

where T_{STR} is the total time using the SRT tree and T_{Quad} is the total time using the Quad tree. A negative S value indicates that the SRT tree is better while a positive S value indicates the Quad tree is better. The absolute value indicates the goodness of the spatial index. It is noted that the value of S does not indicate the SRT tree is S fold better than the Quad tree or vice versa.

In the example of FIG. 14, a performance comparison between STR-Tree and Quad-Tree was conducted by executing 712 queries with each method. For each corresponding pair of queries, the performance metric S was computed, ranging from −2 to 2. An S value of 2 indicates a significant performance advantage for Quad-Tree, whereas a value of −2 indicates a significant advantage for STR-Tree. This process resulted in 712 S values. A histogram was then generated using 50 bins across the range [−2, 2], with the X-axis representing the S value bins and the Y-axis indicating the frequency of values within each bin.

### 2. Adaptive Per-Partition Join Execution

According to some embodiments, the statistics and samples collected during the analysis phase are used to generate per-partition execution plans for the local spatial join. Each partition may be processed using parameters optimized for its specific data distribution. One such parameter is the selection of the build side (i.e., the dataset used to construct the spatial index) and the stream side (i.e., the dataset used to query the index). The algorithm may estimate the relative size of each dataset within a partition based on sample counts and select the smaller dataset as the build side. This approach may reduce memory consumption and improve execution speed.

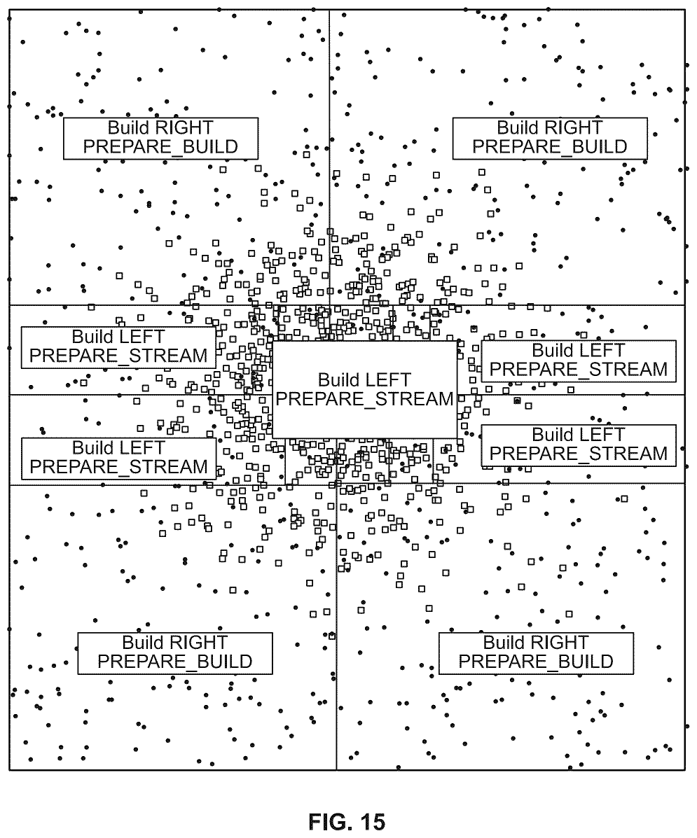

FIG. 15 illustrates an example of per-partition parameterization, where different execution parameters are applied to each partition based on the distribution of samples from the left-side and right-side datasets. More specifically, FIG. 15 illustrates different parameters that can be used for each partition (per-partition local spatial joining parameters) when running local spatial joins to join the dots (left-side) and the larger squares (right-side) datasets.

To enable per-partition parameterization, the partition identifier (ID) must be accessible during local join execution. The standard Spark RDD API does not provide a zipPartitionsWithIndex method. Legacy implementations may use zipPartitions and mapPartitionsWithIndex as a workaround. In contrast, the advanced spatial join algorithm introduces a custom RDD class, ZippedPartitionsWithIndexRDD2, which supports a computation function with the signature (Int, Iterator [T], Iterator [B])=>Iterator [V]. The partition ID, passed as the first argument, may be used to retrieve partition-specific join parameters from a broadcasted array.

### 3. Build Side and Stream Side Selection

According to some embodiments, selecting the smaller dataset as the build side during local spatial join execution can yield significant performance and memory efficiency benefits. For example, assuming B denotes the size of build side and S the size of stream size, the total cost C of indexed spatial join can be expressed by formula (2) below:

$$C = {C}_{build} + {C}_{query} + {C}_{eval} , \qquad ( 2 ) .$$

where C_{build}=B log B represents the cost of building the spatial index, C_{query}=S log B represents the cost of querying the index, and Cₑᵥₐₗ is a constant representing the cost of evaluating spatial predicates. Accordingly, formula (2) may be simplified to formula (3):

$$C = log B ( B + S ) + {C}_{eval} , \qquad ( 3 ) .$$

This formulation highlights the logarithmic dependency on the size of the build side B, which influences both index construction and query performance.

Although constant factors in C_{build} and C_{query} are omitted in the simplified model, they

may still influence the optimal build side selection. Nevertheless, selecting the smaller dataset as the build side generally reduces the total computational cost and minimizes the risk of heap memory exhaustion during index construction. This strategy aligns with the default behavior of Apache Spark when executing hash joins. Empirical evaluations have demonstrated that building the smaller side consistently outperforms building the larger side in terms of execution time and memory usage. More importantly, this approach significantly reduces the likelihood of out-of-memory errors during spatial index creation, thereby improving the robustness and scalability of the spatial join operation.

### 4. Execution Mode Selection for Enhanced Prepared Geometry Utilization

Prepared geometry is a technique used to accelerate spatial operations by preprocessing geometric data into optimized data structures. This preprocessing can significantly improve the performance of certain spatial predicates, though its effectiveness varies depending on the predicate and geometry type. Table 3 below summarizes the applicability of prepared geometry based on the spatial predicate and the geometry type of a left-hand operand. The header of the table indicates the left side of the spatial predicate preparedGeom.<predicate> (otherGeom).

TABLE 3
Applicability of Prepared Geometry Based on a Spatial
Predicate for Left-hand Operand (preparedGeom)

| Predicate | Point | Linear | Polygonal |
|---|---|---|---|
| intersects | ✓ | ✓ | ✓ |
| contains | χ | χ | ✓ |
| covers | χ | χ | ✓ |
| within | χ | χ | χ |
| coveredBy | χ | χ | χ |
| crosses | χ | χ | χ |
| touches | χ | χ | χ |
| overlaps | χ | χ | χ |

Spatial predicates such as the intersects, contains and covers can benefit from prepared geometry when the left operand is preprocessed. For spatial predicates like within and coveredBy, performance gains can be achieved by inverting the predicate and swapping operands. For example, the expression leftGeom.within (rightGeom) can be written as rightGeom.contains (leftGeom), allowing the use of a prepared geometry on the right-hand side:

$$preparedRightGeom = prepare ( rightGeom ) \\ preparedRightGeom \cdot contains ( leftGeom )$$

In the context of indexed spatial joins, the side on which geometries are prepared—either the build side or the stream side—can significantly impact performance. Three execution modes are defined:
(i) PREPARE_BUILD mode: Geometries on the build side are prepared during spatial index construction. In this mode, geometries from the build dataset are preprocessed into optimized data structures (referred to as “prepared geometries”) and inserted into the spatial index. For each geometry in the stream dataset, the system queries the index and applies the spatial predicate to determine spatial relationships. This approach is optimized for scenarios where the build dataset is reused across multiple queries.
(ii) PREPARE_STREAM mode: The stream geometry is prepared to accelerate predicate evaluation across multiple candidate geometries. In this mode, raw geometries from the build dataset are indexed without preparation. The stream dataset geometries are prepared instead. The spatial predicate is logically inverted to accommodate the change in preparation order. This mode is beneficial when the stream dataset is reused or when its geometries are more complex.
(iii) PREPARE_NONE mode: No prepared geometry is used. If no preparation is specified, the system performs a direct spatial join using raw geometries from both datasets. This mode is suitable for lightweight or one-off spatial operations.

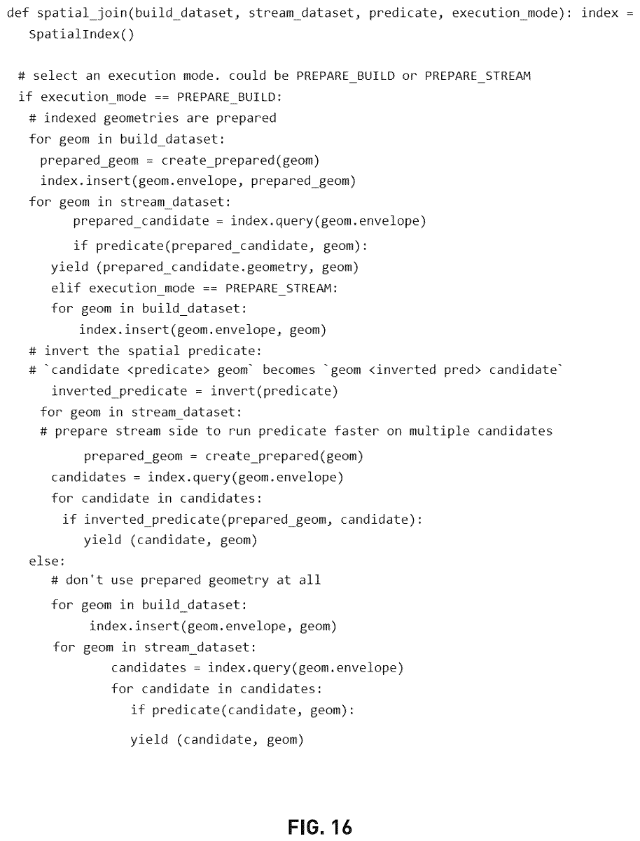

FIG. 16 illustrates pseudocode implementations for each execution mode. In the example of FIG. 16, the executed pseudocode performs spatial join operations between two datasets using an adaptive execution strategy. The method is implemented via a function, referred to herein as spatial_join, which accepts four parameters: a build dataset, a stream dataset, a spatial predicate, and an execution mode. The method constructs a spatial index and selects an execution strategy based on the specified execution mode—PREPARE_BUILD, PREPARE_STREAM, and PREPARE_NONE. The method dynamically adapts to the characteristics of the input datasets and the spatial predicate to optimize performance. The use of prepared geometries significantly accelerates spatial operations by reducing computational overhead, particularly for complex spatial predicates. Predicate inversion ensures correctness when the prepared geometry resides on the stream side of the join. For example, in PREPARE_STREAM mode, the spatial predicate is inverted. For instance, build.<predicate>(stream) is transformed into stream.<inverted predicate>(build) to leverage prepared geometry on the stream side. This adaptive spatial join methodology enhances execution efficiency, reduces memory consumption, and supports scalable spatial data processing in distributed or high-performance computing environments.

Table 4 outlines the recommended execution mode for each predicate when the build side is the left operand.

TABLE 4
Recommended Execution Mode for Each Predicate
when the Build Side is the Left Operand

| Predicate (build side | |
|---|---|
| as left operand) | Execution mode |
| intersects | PREPARE_BUILD or PREPARE_STREAM |
| contains | PREPARE_BUILD |
| covers | PREPARE_BUILD |
| within | PREPARE_STREAM |
| coveredBy | PREPARE_STREAM |
| any other predicates | PREPARE_NONE |

Both PREPARE_BUILD and PREPARE_STREAM modes are effective for the intersects predicate. Empirical results indicate that PREPARE_STREAM may offer superior performance due to improved cache locality and higher cache hit rates. However, PREPARE_BUILD may be preferable under the following conditions:
1. The build-side geometries are polygons and the stream-side geometries are points, as polygon preparation yields greater performance benefits.
2. The build-side geometries are significantly more complex than those on the stream side (e.g., an order of magnitude more vertices).

In some embodiments, geometry type and complexity metrics collected during an analysis phase can be used to dynamically select the optimal execution mode for the intersects predicate.

### IV. Additional Improvements

### 1. Broadcast Indexed Join Optimization

In some embodiments, the broadcast indexed spatial join operation may be optimized by dynamically selecting an execution mode based on the specific spatial predicate being evaluated. The execution modes—PREPARE_BUILD, PREPARE_STREAM, and PREPARE_NONE—can be applied within the BroadcastIndexJoinExec operator to improve performance across a broader range of spatial predicates, including but not limited to intersects, contains, and covers. For example, when evaluating intersects, both PREPARE_BUILD and PREPARE_STREAM modes are viable. If the build-side geometries are complex polygons and the stream-side geometries are simple points, PREPARE_BUILD may be preferred to reduce redundant preparation. Conversely, if the stream-side geometries are reused across many build-side candidates, PREPARE_STREAM may yield better cache locality and performance. This adaptive execution mode selection enables the BroadcastIndexJoinExec operator to optimize spatial joins based on both the predicate semantics and the geometry characteristics (e.g., type and complexity). In some embodiments, these decisions may be informed by metadata collected during an analysis phase, such as geometry type distributions or vertex counts.

### Some Embodiments

Some embodiments may include any of the following:

A1. A computer-implemented method for performing an optimized spatial join operation between geospatial datasets. The computer-implement includes analyzing each geospatial dataset to extract spatial metadata, where analyzing includes performing an one-pass scan of each geospatial dataset to collect spatial metadata. The computer-implemented method further includes applying a heuristic-based method to identify an optimal number of partitions for each geospatial dataset, and applying a hybrid sampling strategy which includes Reservoir sampling and Bernoulli sampling for each partition to collect respective spatial metadata. The computer-implemented method also includes generating spatial partitions based on the extracted spatial metadata, where generating the spatial partitions includes shuffling collected samples to reduce spatial bias, increasing the number of samples to improve partition uniformity, and mixing samples from all geospatial datasets to improve the spatial distribution of a join workload. The computer-implemented method also includes performing a spatial join operation which includes dynamically selecting a spatial index structure to execute local joins within each partition, and executing an adaptive per-partition local join execution plan by estimating which geospatial dataset is smaller and designating the smaller geospatial dataset as a build side.

A2. The computer-implemented method of clause A1 can include any of the following components or features, in any combination. Where analyzing further includes executing the one pass-scan on all geospatial datasets concurrently. Where each geospatial dataset is of an unknown size. Where applying the hybrid sampling strategy includes applying the Reservoir sampling to maintain a fixed-size uniform sample from a sampled geospatial dataset, and applying the Bernoulli sampling to probabilistically include each record based on a predefined sampling rate. Where applying the hybrid sampling strategy further includes initiating an envelop collection when observed records k is less than a minimum number of samples Nₘᵢₙ, performing a small Reservoir sampling when k is greater than or equal to Nₘᵢₙ and less than a threshold value

$$\frac{{N}_{m i n}}{R} ,$$

performing the Bernoulli sampling when k is greater than or equal to

$$\frac{{N}_{m i n}}{R}$$

and a size of a set of sampled envelopes ∥S∥ is less than a maximum number of samples Nₘₐₓ, and performing a large Reservoir sampling when ∥S∥ is equal to Nₘₐₓ. Where the spatial index structure includes Quad trees and Sort-Tile-Recursive (STR) trees. Where dynamically selecting the spatial index structure includes selecting the spatial index structure based on a spatial intext score S. Where an absolute value of the spatial intext score S indicates a goodness of the spatial index. Where executing an adaptive per-partition local join execution plan includes selecting an execution strategy based on a specified execution mode, the specified execution mode comprising any of PREPARE_BUILD, PREPARE_STREAM, and PREPARE_NONE.

A3. A computing apparatus including one or more processors. The computing apparatus also includes a memory for storing instructions that, when executed by the one or more processors, configure the computing apparatus to perform an optimized spatial join operation between geospatial datasets. The optimized spatial join operation includes analyzing each geospatial dataset to extract spatial metadata, where analyzing includes performing an one-pass scan of each geospatial dataset to collect spatial metadata, applying a heuristic-based method to identify an optimal number of partitions for each geospatial dataset, and applying a hybrid sampling strategy that includes Reservoir sampling and Bernoulli sampling for each partition to collect respective spatial metadata. The optimized spatial join operation further includes generating spatial partitions based on the extracted spatial metadata, where generating the spatial partitions includes shuffling collected samples to reduce spatial bias, increasing the number of samples to improve partition uniformity, and mixing samples from all geospatial datasets to improve the spatial distribution of a join workload. In addition, the optimized spatial join operation includes performing a spatial join operation that includes dynamically selecting a spatial index structure to execute local joins within each partition, and executing an adaptive per-partition local join execution plan by estimating which geospatial dataset is smaller and designating the smaller geospatial dataset as a build side.

A4. The optimized spatial join operation of clause A3 can include any of the following components or features, in any combination. Where analyzing further includes executing the one pass-scan on all geospatial datasets concurrently. Where each geospatial dataset is of an unknown size. Where applying the hybrid sampling strategy includes applying the Reservoir sampling to maintain a fixed-size uniform sample from a sampled geospatial dataset, and applying the Bernoulli sampling to probabilistically include each record based on a predefined sampling rate. Where applying the hybrid sampling strategy further includes initiating an envelop collection when observed records k is less than a minimum number of samples Nₘᵢₙ, performing a small Reservoir sampling when k is greater than or equal to Nₘᵢₙ and less than a threshold value

$$\frac{{N}_{m i n}}{R} ,$$

performing the Bernoulli sampling when k is greater than or equal to

$$\frac{{N}_{m i n}}{R}$$

and a size of a set of sampled envelopes ∥S∥ is less than a maximum number of samples Nₘₐₓ, and performing a large Reservoir sampling when ∥S∥ is equal to Nₘₐₓ. Where the spatial index structure includes Quad trees and Sort-Tile-Recursive (STR) trees. Where dynamically selecting the spatial index structure includes selecting the spatial index structure based on a spatial intext score S. Where an absolute value of the spatial intext score S indicates a goodness of the spatial index. Where executing an adaptive per-partition local join execution plan includes selecting an execution strategy based on a specified execution mode, the specified execution mode comprising any of PREPARE_BUILD, PREPARE_STREAM, and PREPARE_NONE.

### Additional Considerations

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some embodiments, aspects of the systems and methods described herein may be implemented using ML and/or AI technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for performing an optimized spatial join operation between geospatial datasets, the computer-implement comprising:
analyzing each geospatial dataset to extract spatial metadata, wherein analyzing comprises:
performing an one-pass scan of each geospatial dataset to collect spatial metadata;
applying a heuristic-based method to identify an optimal number of partitions for each geospatial dataset; and
applying a hybrid sampling strategy comprising Reservoir sampling and Bernoulli sampling for each partition to collect respective spatial metadata;
generating spatial partitions based on the extracted spatial metadata, wherein generating the spatial partitions comprises:
shuffling collected samples to reduce spatial bias;
increasing the number of samples to improve partition uniformity; and
mixing samples from all geospatial datasets to improve the spatial distribution of a join workload; and
performing a spatial join operation comprising:
dynamically selecting a spatial index structure to execute local joins within each partition; and
executing an adaptive per-partition local join execution plan by estimating which geospatial dataset is smaller and designating the smaller geospatial dataset as a build side.

2. The computer-implemented method of claim 1, wherein analyzing further comprises executing the one pass-scan on all geospatial datasets concurrently.

3. The computer-implemented method of claim 1, wherein each geospatial dataset has unknown size.

4. The computer-implemented method of claim 1, wherein applying the hybrid sampling strategy comprises:
applying the Reservoir sampling to maintain a fixed-size uniform sample from a sampled geospatial dataset; and
applying the Bernoulli sampling to probabilistically include each record based on a predefined sampling rate.

5. The computer-implemented method of claim 4, wherein applying the hybrid sampling strategy further comprises:
initiating an envelop collection when observed records k is less than a minimum number of samples Nₘᵢₙ;
performing a small Reservoir sampling when k is greater than or equal to Nₘᵢₙ and less than a threshold value
$$\frac{{N}_{m i n}}{R} ;$$
performing the Bernoulli sampling when k is greater than or equal to
$$\frac{{N}_{m i n}}{R}$$
and a size of a set of sampled envelopes ∥S∥ is less than a maximum number of samples Nₘₐₓ; and
performing a large Reservoir sampling when ∥S∥ is equal to Nₘₐₓ.

6. The computer-implemented method of claim 1, wherein the spatial index structure comprises Quad trees and Sort-Tile-Recursive (STR) trees.

7. The computer-implemented method of claim 1, wherein dynamically selecting the spatial index structure comprises selecting the spatial index structure based on a spatial intext score S.

8. The computer-implemented method of claim 7, wherein an absolute value of the spatial intext score S indicates a goodness of the spatial index.

9. The computer-implemented method of claim 1, wherein performing the spatial join operation further comprising preprocessing geometric data into optimized data structures to accelerate spatial operations.

10. The computer-implemented method of claim 1, wherein executing an adaptive per-partition local join execution plan comprises selecting an execution strategy based on a specified execution mode, the specified execution mode comprising any of PREPARE_BUILD, PREPARE_STREAM, and PREPARE_NONE.

11. A computing apparatus comprising:
one or more processors; and
a memory for storing instructions that, when executed by the one or more processors, configure the computing apparatus to perform an optimized spatial join operation between geospatial datasets, the optimized spatial join operation comprising:
analyzing each geospatial dataset to extract spatial metadata, wherein analyzing comprises:
performing an one-pass scan of each geospatial dataset to collect spatial metadata;
applying a heuristic-based method to identify an optimal number of partitions for each geospatial dataset; and
applying a hybrid sampling strategy comprising Reservoir sampling and Bernoulli sampling for each partition to collect respective spatial metadata;
generating spatial partitions based on the extracted spatial metadata, wherein generating the spatial partitions comprises:
shuffling collected samples to reduce spatial bias;
increasing the number of samples to improve partition uniformity; and
mixing samples from all geospatial datasets to improve the spatial distribution of a join workload; and
performing a spatial join operation comprising:
dynamically selecting a spatial index structure to execute local joins within each partition; and
executing an adaptive per-partition local join execution plan by estimating which geospatial dataset is smaller and designating the smaller geospatial dataset as a build side.

12. The computing apparatus of claim 11, wherein analyzing further comprises executing the one pass-scan on all geospatial datasets concurrently.

13. The computing apparatus of claim 11, wherein each geospatial dataset has unknown size.

14. The computing apparatus of claim 11, wherein applying the hybrid sampling strategy comprises:
applying the Reservoir sampling to maintain a fixed-size uniform sample from a sampled geospatial dataset; and
applying the Bernoulli sampling to probabilistically include each record based on a predefined sampling rate.

15. The computing apparatus of claim 14, wherein applying the hybrid sampling strategy further comprises:
initiating an envelop collection when observed records k is less than a minimum number of samples Nₘᵢₙ;
performing a small Reservoir sampling when k is greater than or equal to Nₘᵢₙ and less than a threshold value
$$\frac{{N}_{m i n}}{R} ;$$
performing the Bernoulli sampling when k is greater than or equal to
$$\frac{{N}_{m i n}}{R}$$
and a size of a set of sampled envelopes ∥S∥ is less than a maximum number of samples Nₘₐₓ; and
performing a large Reservoir sampling when ∥S∥ is equal to Nₘₐₓ.

16. The computing apparatus of claim 11, wherein the spatial index structure comprises Quad trees and Sort-Tile-Recursive (STR) trees.

17. The computing apparatus of claim 11, wherein dynamically selecting the spatial index structure comprises selecting the spatial index structure based on a spatial intext score S.

18. The computer-implemented method of claim 17, wherein an absolute value of the spatial intext score S indicates a goodness of the spatial index.

19. The computing apparatus of claim 11, wherein performing the spatial join operation further comprising preprocessing geometric data into optimized data structures to accelerate spatial operations.

20. The computing apparatus of claim 11, wherein executing an adaptive per-partition local join execution plan comprises selecting an execution strategy based on a specified execution mode, the specified execution mode comprising any of PREPARE_BUILD, PREPARE_STREAM, and PREPARE_NONE.
